(19) United States
(12) Patent Application Publication
(10) Pub. No.: US 2026/0059216 A1
(43) Pub. Date: Feb. 26, 2026

(54) THREE-DIMENSIONAL DECORATIVE OBJECT WITH MOTION POWERING SPEAKER

(71) Applicant: Hallmark Cards, Incorporated, Kansas City, MO (US)

(72) Inventors: ELIZABETH IRENE HORVATIC, KANSAS CITY, MO (US); LAP MAN MA, KOWLOON (HK)

(21) Appl. No.: 19/305,273

(22) Filed: Aug. 20, 2025

Related U.S. Application Data
(60) Provisional application No. 63/685,336, filed on Aug. 21, 2024.

(51) Int. Cl. H04R 1/02

(52) U.S. Cl. CPC H04R 1/026; H04R 1/025; H04R 1/028; H04R 2201/025

(57) ABSTRACT

A three-dimensional decorative object having a base, a speaker coupled to the base, and an ornamental component. The ornamental component has a first portion that is coupled to the base, and a second portion that is movably coupled to the first portion. The second portion is positioned adjacent the speaker. A third portion may be movably coupled to the first portion and the second portion. The base may have a housing and a guide coupled to the housing. The second portion may slidably couple to the guide and be configured to move relative to the first portion when the speaker vibrates.

### CROSS-REFERENCE TO RELATED APPLICATIONS

This application is based on and claims priority to U.S. Provisional Application Ser. No. 63/685,336, filed on Aug. 21, 2024, which is incorporated herein by reference in its entirety.

### BACKGROUND OF THE INVENTION

Ornaments have been around for hundreds of years. Traditionally, ornaments are thought of as glass decorations hung from a Christmas tree. However, ornaments are not limited to Christmas and can be used to decorate a space for any holiday or simply to add an attractive decoration to the space. Ornaments have evolved to intricate decorative objects which people joyfully display in homes, offices, and stores year round.

### BRIEF SUMMARY OF THE INVENTION

A three-dimensional decorative object in accordance with one exemplary embodiment of the invention described herein includes a base, a speaker coupled to the base, and an ornamental component. The ornamental component has a first portion that is coupled to the base and a second portion that is movably coupled to the first portion. The second portion is positioned adjacent the speaker and is configured to move relative to the first portion when the speaker vibrates.

In some embodiments, the base may include a housing and a speaker mount that is coupled to the housing. The speaker mount mounts the speaker to the housing. The first portion may be modeled to represent a person. The second portion may be modeled to represent a jack hammer.

In some embodiments, a film may be coupled to the speaker and positioned between the speaker and the second portion. The second portion may be adhered to the film.

In some embodiments, the base may have a housing and a guide coupled to the housing. The second portion may be slidably mounted to the guide.

In some embodiments, the ornamental component may further include a third portion configured to move relative to the first portion and the second portion. The third portion may have an elongated component movably coupled to the second portion and at least one arm extending from the elongate component and movably coupled to the first portion. The third portion may be modeled to represent handle bars of a jack hammer.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a perspective view of a three-dimensional decorative object in accordance with an exemplary embodiment of the invention described herein;

FIG. 2 is a perspective view of the three-dimensional decorative object with a housing of the object removed;

FIG. 3A is a cross-sectional view taken through the line 3A of FIG. 3C;

FIG. 3B is a cross-sectional view taken through the line 3B of FIG. 3C;

FIG. 3C is a top plan view of the three-dimensional decorative object of FIG. 1;

FIG. 4 is a perspective view of a housing of the decorative object of FIG. 1;

FIG. 5 is a bottom plan view of the housing shown in FIG. 4;

FIG. 6 is a cross-sectional view taken through the line 3A of FIG. 3C showing only the housing and a speaker;

FIG. 7 is a top plan view of a speaker mount of the three-dimensional decorative object;

FIG. 8 is a bottom plan view of the speaker mount coupled to the housing;

FIG. 9 is a bottom plan view of the housing showing a plate coupled to it;

FIG. 10 is a view similar to FIG. 9 but showing a battery compartment of the plate;

FIG. 11 is a perspective view of the housing showing an actuator;

FIG. 12 is a top plan view of the actuator and a circuit board;

FIG. 13 is a perspective view of the circuit board wired to the speaker;

FIG. 14 is a perspective view of a guide of the three-dimensional decorative object;

FIG. 15 is a perspective view of the guide coupled to the housing;

FIG. 16 is a perspective view of a film coupled to the speaker;

FIG. 17 is a perspective view of a jack hammer of the object adjacent the guide and the speaker;

FIG. 18 shows a portion of the jack hammer slidably engaging the guide;

FIG. 19 is a front elevational view of the jack hammer with a front cover of the jack hammer removed;

FIG. 20 is a perspective view of an upper portion of the jack hammer; and

FIG. 21 is a cross sectional view showing arms coupled to a body of the decorative object.

### DETAILED DESCRIPTION OF EXEMPLARY EMBODIMENT

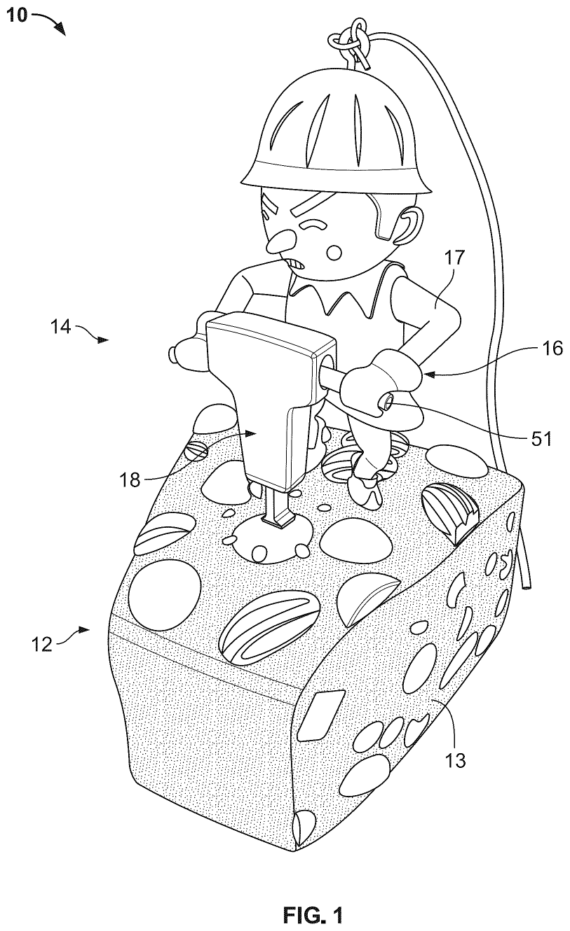

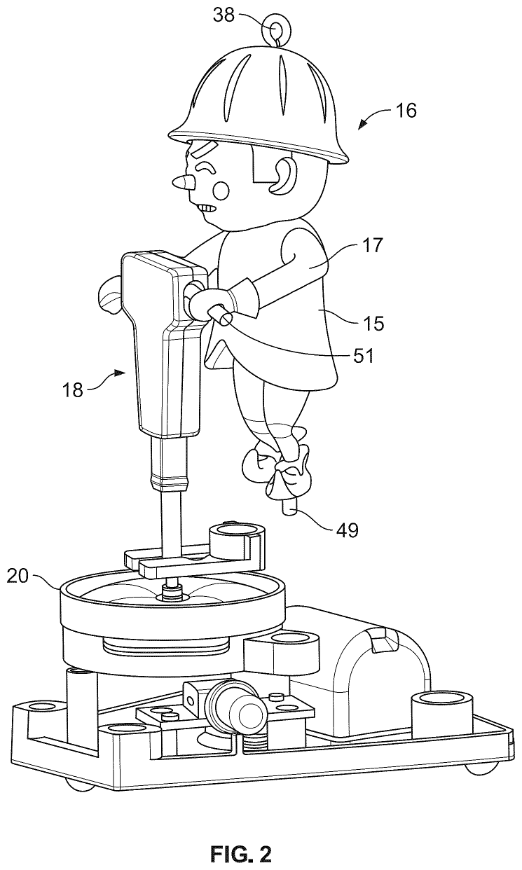

A three-dimensional decorative object in accordance with one exemplary embodiment of the invention described herein is identified generally as 10 in FIG. 1. The three-dimensional decorative object 10 includes a base 12 and an ornamental component 14. The ornamental component 14 is a model of a person or elf (also referred to herein as a “first portion”) 16 operating a jack hammer (also referred to herein as a “second portion”) 18. The person 16 is coupled to the base 12, and the jack hammer 18 is movably coupled to the person 16 and the base 12. As shown in FIG. 2, the three-dimensional decorative object 10 also includes a speaker 20. As described in more detail below, the jack hammer 18 is positioned adjacent the speaker 20 and is configured to move relative to the person 16 and the base 12 when the speaker 20 vibrates. While the ornamental component 14 in this embodiment is shown as a person 16 with a jack hammer 18, the invention described herein covers any three-dimensional decorative object having an ornamental component comprising a first portion that is coupled to a base and a second portion that is movably coupled to the first portion, wherein the second portion is positioned adjacent the speaker and configured to move relative to the first portion when the speaker vibrates.

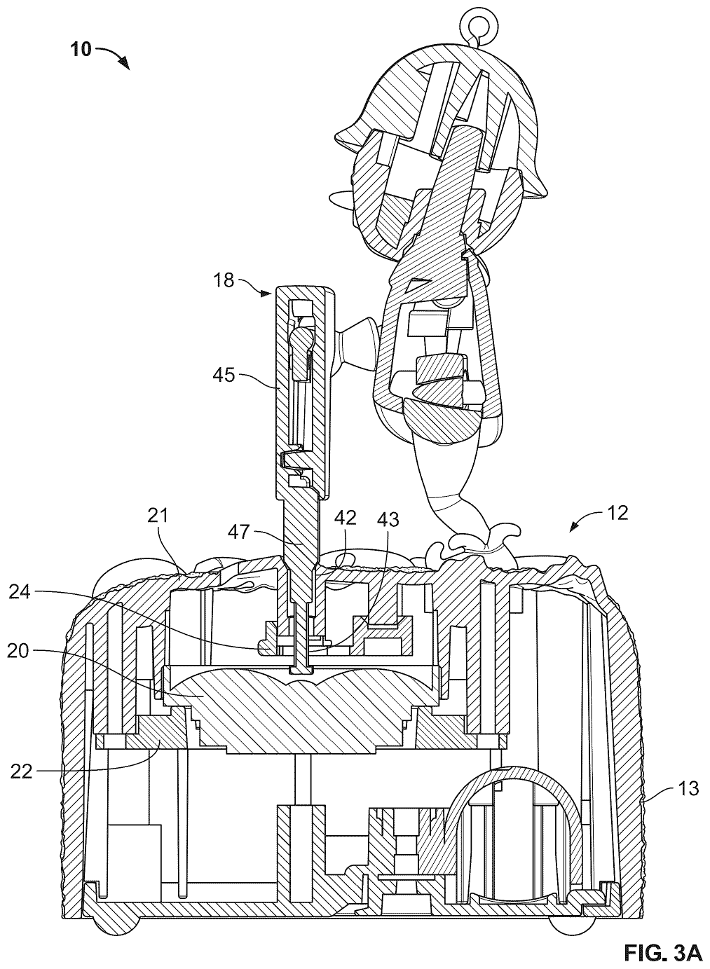

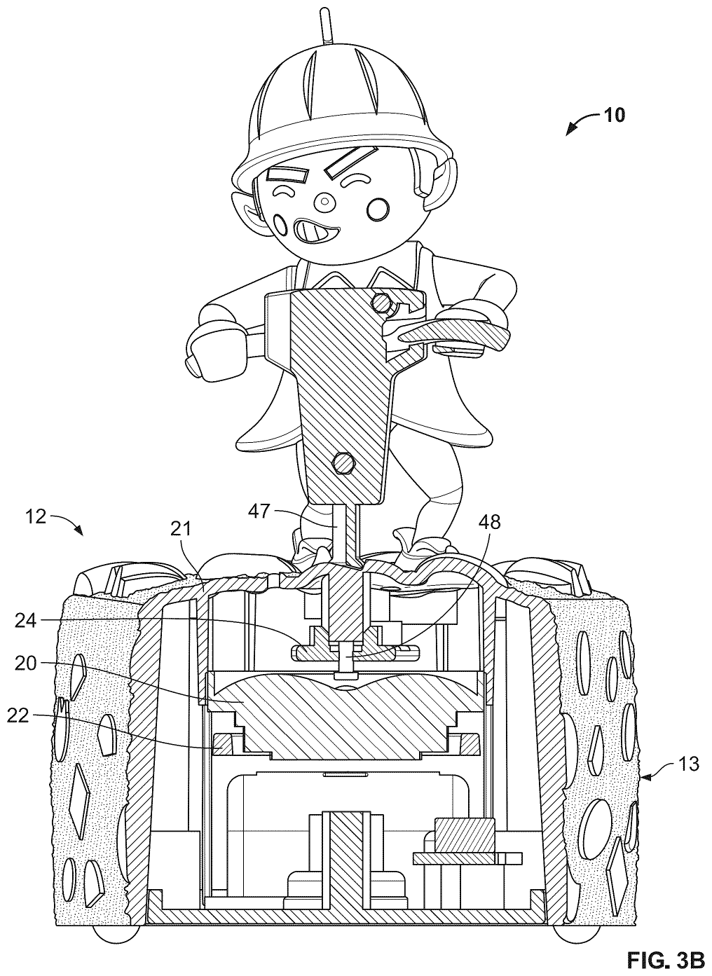

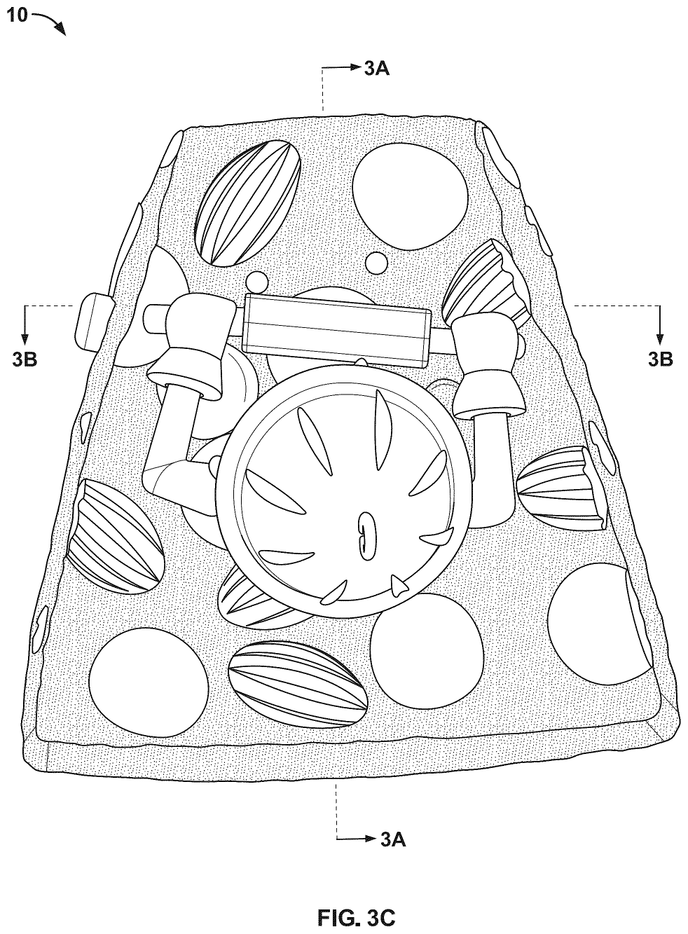

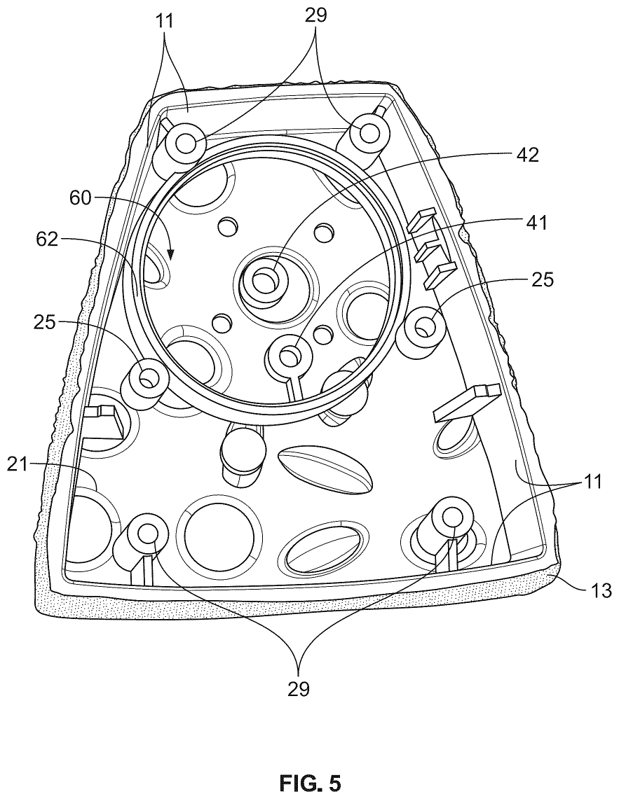

As shown in FIG. 3A, the base 12 includes a housing 13, a speaker mount 22 joined to the housing 13, and a guide 24 joined to the housing 13. As shown in FIG. 5, the housing 13 has an inner volume defined by a top wall 21 and a plurality of side walls 11. The housing 13 in this embodiment has four side walls 11 defining the inner volume of the housing 13, however the invention covers a housing having any number of side walls which could be crafted to create an inner volume as described herein. For example, the housing 13 could be circular with one side wall or hexagonal with six side walls. As shown in FIG. 1, the housing 13 is modeled after a fruit cake. However, this invention covers any three-dimensional decorative object, e.g., a housing which is modeled after a cookie, a cake, a rock, a piece of gold, or any other desirable item.

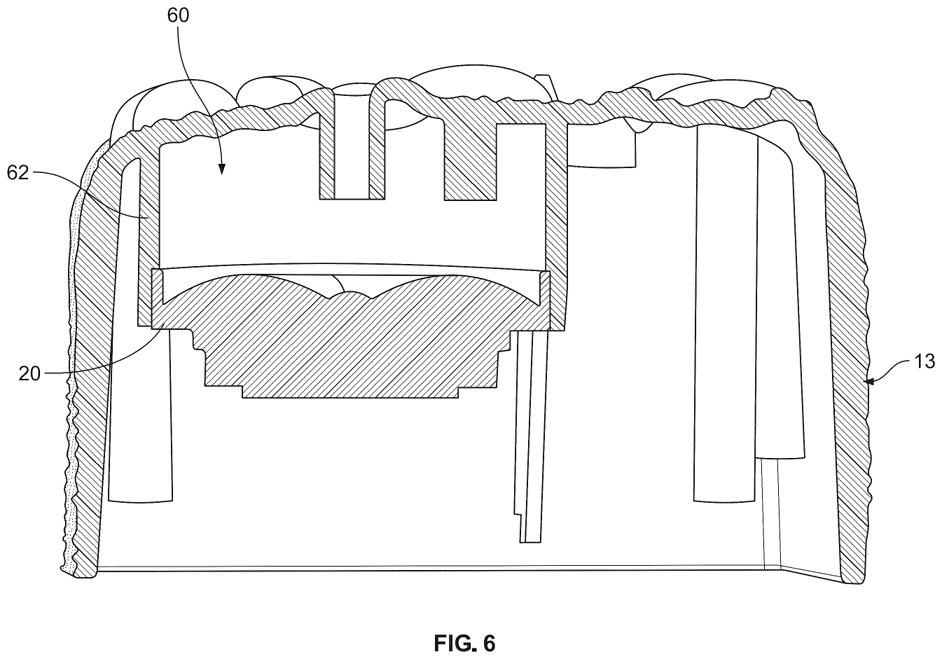

As further shown by FIG. 5, the housing 13 has a speaker receiving area 60. The receiving area 60 comprises a partition 62 extending from the top wall 21 of the housing 13 into the volume defined by the housing 13. The size and shape of the speaker receiving area 60 is configured such that the speaker 20 fits securely within the speaker receiving area 60, as shown in FIG. 6. For example, the outer diameter of the speaker 20 aligns with the inner diameter of the speaker receiving area 60. The speaker receiving area 60 may be configured such that the movement of the speaker 20 into the receiving area 60 is limited. For example, the partition 62 of the speaker receiving area 60 may be recessed such that the diameter of the speaker receiving area 60 becomes less than the outer diameter of the speaker 20 to position the speaker 20 a distance from the top wall 21. The speaker receiving area 60 may also have a bevel, notch, or any other structure that will prevent the speaker from moving further into the speaker receiving area 60 than desired.

Turning to FIGS. 3A and 3B, a cross sectional view of the three-dimensional decorative object 10 shows how the speaker 20, speaker mount 22, and guide 24 are positioned within the volume defined by the housing 13. FIG. 3C is a perspective view showing the lines defining the cross sectional views of FIGS. 3A and 3B.

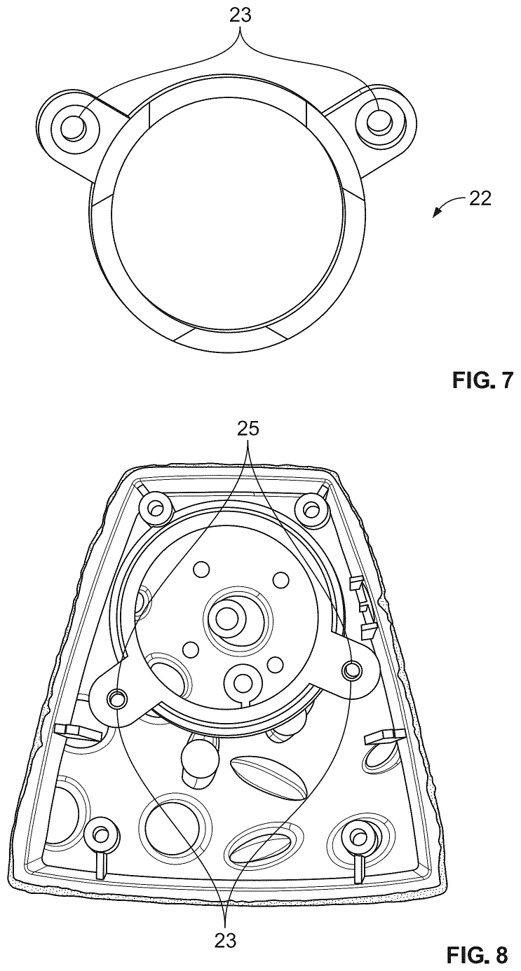

The speaker mount 22 is configured to receive the speaker 20 and be coupled to the housing 13. As shown in FIG. 7, the speaker mount 22 may be generally circular. However, the size and shape of the speaker mount 22 may be any size or shape as desired to mount the speaker 20 to the housing 13. The speaker mount 22 may have at least one manner of coupling the mount 22 to the housing 13. For example, the speaker mount 22 shown in FIG. 7 has two holes 23 configured to couple the mount 22 to the housing 13. As shown in FIG. 8, the speaker mount holes 23 are configured to align with threaded openings 25 in the volume defined by the housing 13. For example, the mount 22 is coupled to the housing 13 by threading a screw through each of the speaker mount holes 23 to engage with the threaded openings 25 in the housing 13. In the particular embodiment shown in FIG. 8, the speaker mount 22 is coupled to the housing 13 with two screws. Alternatively, the speaker mount 22 may be coupled to the housing 13 in a way that is readily available to one skilled in the art. When the speaker mount 22 is joined to the housing 13, the speaker 20 is mounted to the housing 13 between the speaker mount 22 and a portion of the partition 62.

The base 12 of the three-dimensional decorative object 10 also includes a plate 26 which couples to the housing 13, as shown in FIG. 9. The plate 26 is positioned in the space defined by the plurality of side walls 11 such that the volume defined by the housing 13 is substantially enclosed. The plate 26 has four holes 27. The plate holes 27 are positioned to align with threaded openings 29 (FIG. 5) in the volume defined by the housing 13 such that a screw may be fed through each hole 27 and engage one of the threaded openings 29 to couple the plate 26 to the housing 13. The exemplary embodiment of the invention shows the threaded openings 29 positioned within the volume defined by the housing 13. Alternatively, the plate 26 may be coupled to the housing by any desirable method.

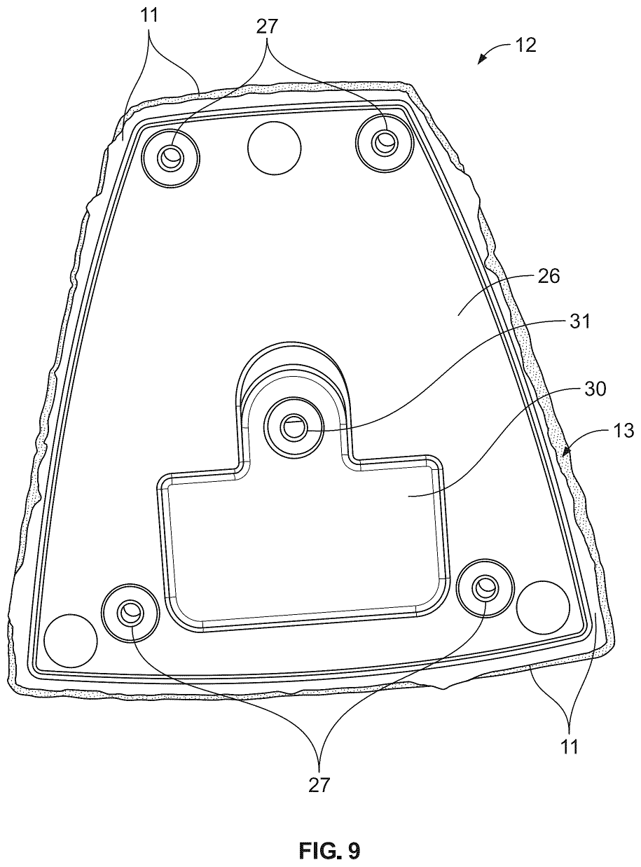

FIG. 10 shows a battery compartment 28 formed in the plate 26. The battery compartment 28 is configured such that it is accessible when the plate 26 is coupled to the housing 13. The battery compartment 28 is configured to be the size and shape that is commonly known to one skilled in the art to receive one or more batteries. The battery may be any battery that is appropriate to provide power to the speaker 20. For example, the battery compartment may be configured to receive three 1.5 V, AG13/LR44 batteries.

The plate 26 includes a cover 30 configured to enclose the battery compartment 28, as shown in FIG. 9. The cover 30 is removably coupled to the plate 26 such that the surface of the cover 30 is flush with the surface of the plate 26. The cover 30 has a hole 31 (FIG. 9) which is configured to align with a hole 32 in the plate 26, shown in FIG. 10. The cover 30 and the plate 26 are coupled by threading a screw through the aligned cover hole 31 and the plate hole 32. Alternatively, the cover may be coupled to the plate in any other desirable manner.

As shown in FIG. 1, the three-dimensional decorative object 10 is configured to be displayed with the plate 26 on the bottom. Accordingly, the outer surface of the plate 26 is generally flat. As shown in FIG. 10, the plate 26 may have a plurality of nodules 33 such that the three-dimensional decorative object 10 sits on the nodules 33 when displayed on a surface. Although in this embodiment the plate 26 has three nodules 33, the three-dimensional decorative object 10 of this invention may contain any number of nodules.

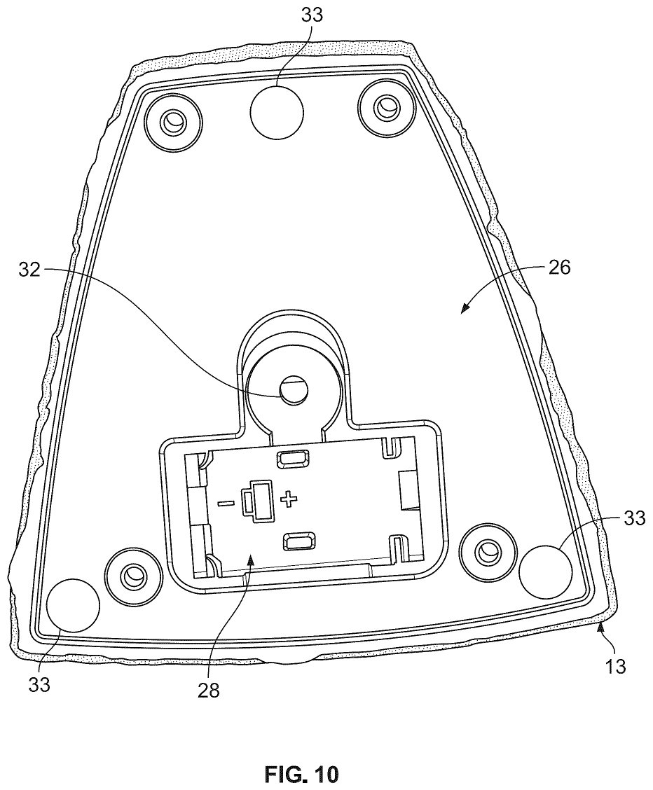

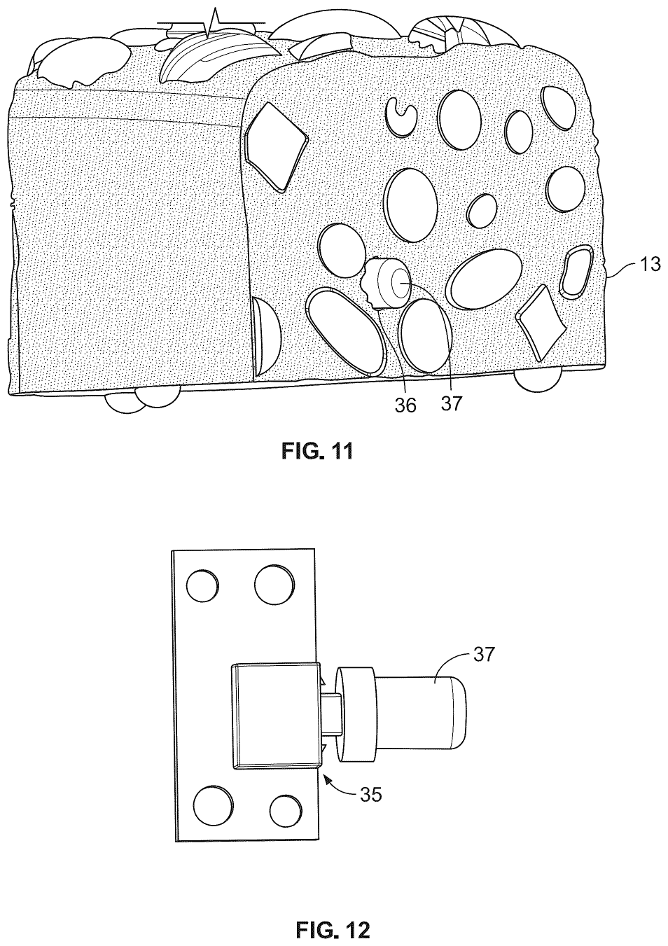

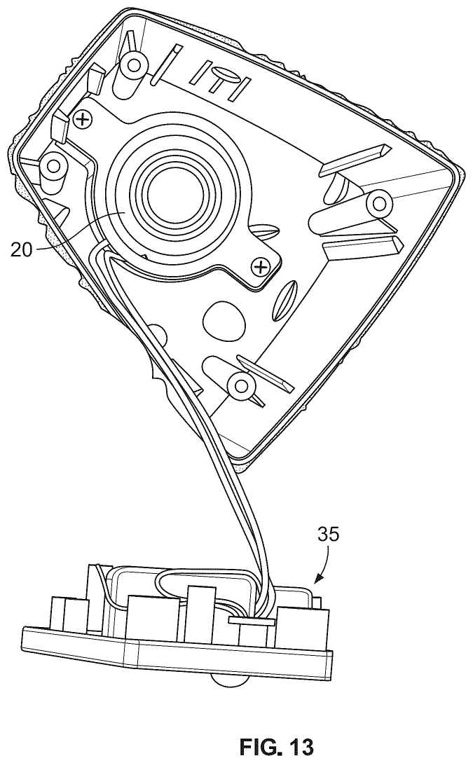

The battery or batteries housed in the battery compartment 28 are wired to a circuit board 35, shown in FIG. 13, to power the circuit board 35 and speaker 20. The circuit board 35 is positioned within the volume defined by the housing 13. As shown in FIG. 13, the circuit board 35 is wired to the speaker 20. The wiring may be achieved in any manner that is readily available to one with ordinary skill in the art. As shown in FIG. 12, the circuit board 35 is coupled to an actuator 37. The actuator 37 extends through an opening 36 in the housing 13 such that the actuator extends past the surface of the housing 13, as shown in FIG. 11. Alternatively, the actuator 37 can be flush with the surface of the housing 13 or recessed within the surface of the housing 13. When the actuator 37 is activated, by for example pressing it, the circuit board 35 sends a signal to the speaker 20 for a period of time. When the speaker 20 receives the signal, the speaker 20 vibrates and may emit sound.

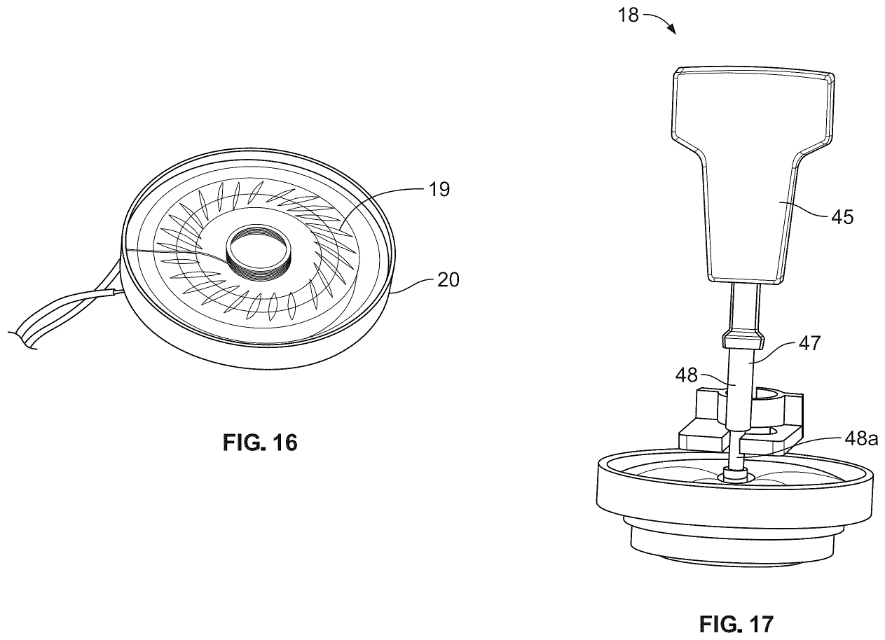

As shown in FIG. 16, a film 19 is adhered to the speaker 20. The film 19 vibrates when the speaker 20 vibrates. The film 19 may be made of any material favorable to the vibration and sound of the speaker 20. For example, the film 19 may be made of polyethylene terephthalate (PET). The speaker may be configured to vibrate at a frequency from about 50 to about 80 Hz.

The size and shape of the speaker affects the vibration. For example, a larger diameter speaker may cause the ornamental component 14 to vibrate in a more obvious manner, to an observer, as compared to a speaker with a smaller diameter. The speaker may have a diameter of around 29 mm in some embodiments. Alternatively, the speaker may have a diameter of between about 20 mm to about 60 mm, or any other desired size.

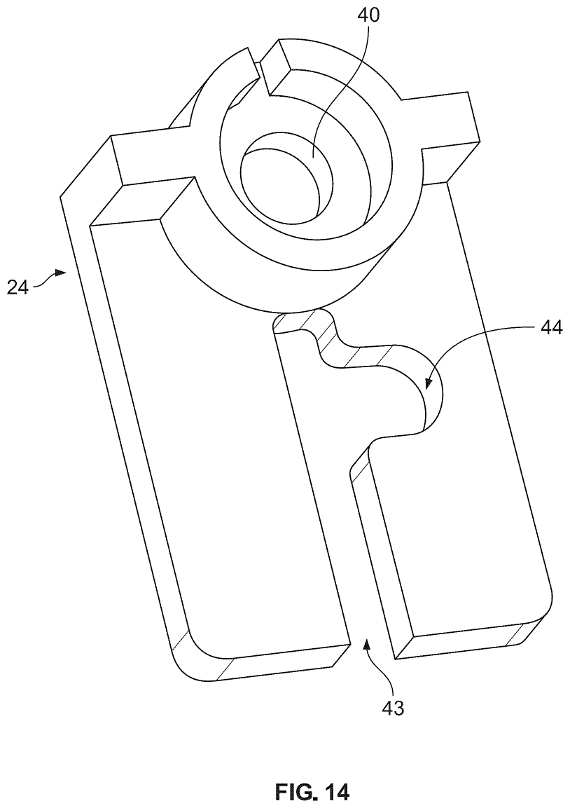

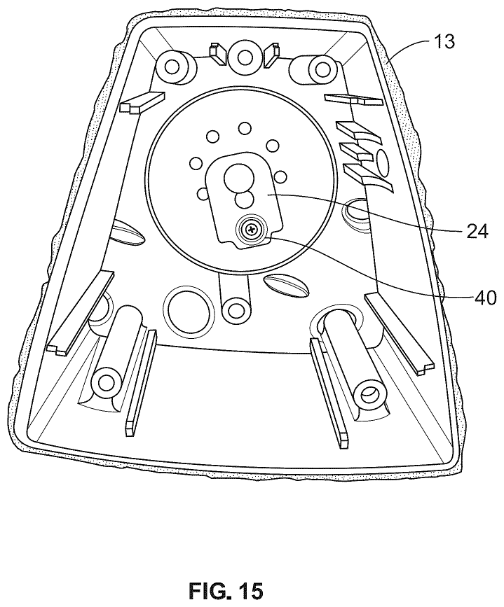

The base 12 also includes a guide 24 which is coupled to the housing 13, as shown in FIGS. 3A and 3B. The guide 24 is positioned within the volume defined by the housing 13 such that the guide 24 is between the speaker 20 and the housing top wall 21. As shown in FIG. 14, the guide 24 has a hole 40 configured to receive a screw. The hole 40 is configured to be aligned with a threaded opening 41 in the housing 13, shown in FIG. 5. As shown in FIG. 15, the guide 24 is coupled to the housing 13 by threading a screw through the hole 40 of the guide and into engagement with the housing threaded opening 41. Alternatively, the guide 24 may be coupled to the housing 13 in any manner that is readily available to one with ordinary skill in the art.

As shown in FIG. 14, the guide 24 has an opening 43 which is configured to slidably receive a shaft 47 (FIGS. 3A and 3B) of the jack hammer 18. As shown in FIG. 14, the opening 43 may be elongated with a notch 44 for receiving the shaft 47. Alternatively, the guide opening 43 may be configured in any way to appropriately receive the shaft 47 of the jack hammer 18.

As shown in FIG. 17, the jack hammer 18 has a body 45 and a shaft 47. As shown in FIG. 5, the housing 13 has an opening 42 in the top wall 21 which is configured to receive the shaft 47 of the jack hammer 18. Turning to FIG. 3A, the shaft 47 extends from the body 45 through the opening 42 of the housing 13 and through the opening 43 of the guide 24 such that one end of the jack hammer 18 is adjacent the speaker 20. The end of the shaft 47 which is adjacent the speaker 20 may be adhered to the film 19 on the speaker 20. Use of the film 19 may enhance vibration and movement of the shaft 47. The end of the shaft 47 may be adhered or coupled to the film 19 or speaker 20 in any desired manner. Consequently, the jack hammer 18 is configured to move when the speaker 20 vibrates or emits sound due to a signal being sent to the speaker from the circuit board 35. The shaft 47 is positioned within the opening 43 of the guide 24 and adhered to the film 19 so that the movement of the jack hammer 18 is generally in one direction (e.g., in a direction aligned with a central axis of the shaft 47).

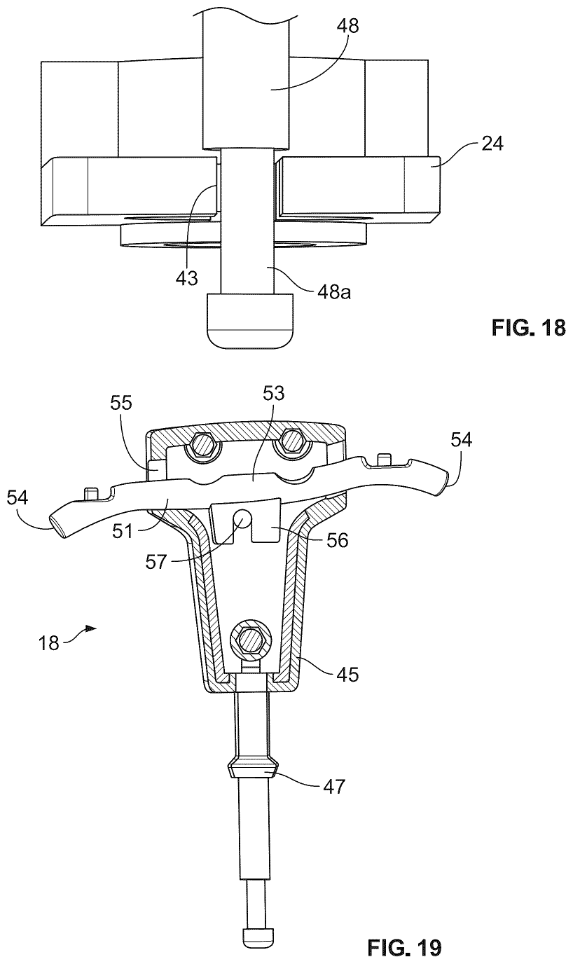

Shown in FIG. 3B, the shaft 47 has a lower section 48 which is the portion of the shaft 47 positioned within the volume defined by the housing 13. The lower section 48 is generally not visible when the three-dimensional decorative object 10 is on display. As shown in FIG. 17, the lower section 48 is generally cylindrical. Turning to FIG. 18, a close up perspective of the lower section 48, the lower section 48 may have an indention such that a portion 48a of the lower section 48 has a smaller diameter than the remainder of the lower section 48. The indented portion 48a of the lower section 48 is positioned within the opening 43 of the guide 24. As shown in FIG. 18, the width of the guide opening 43 is wide enough to slidably receive the indented portion 48a of the lower section 48. However, the guide opening 43 is not wide enough to receive the remainder of the lower section 48. Thus, once the guide 24 slidably receives the indented portion 48a of the lower section 48, the movement of the shaft 47 is limited to the height of the indented portion 48a of the lower section 48. As the shaft 47 moves relative to the guide 24, the surfaces created by the difference in diameter between the indented portion 48a of the lower section 48 and the remainder of the lower section 48 make contact with the upper and lower surfaces of the guide 24 stopping the movement of the shaft 47. Consequently, limiting the movement of the jack hammer 18.

As shown in FIG. 17, the jack hammer 18 has a body 45 with the shaft 47 extending downward from the body 45. As shown in FIG. 19, the jack hammer 18 has a volume which is defined by the body 45. The body 45 is joined to the shaft 47. The shaft 47 of the jack hammer 18 may be fixedly joined to the lower end of the body 45 such that the body 45 moves with the shaft 47 when the speaker 20 vibrates. The weight of the jack hammer 18 may affect the vibration of the jack hammer 18 when the speaker 20 vibrates. For example, a heavier jack hammer 18 may experience less vibration than a lighter weight jack hammer 18 when adjacent the same size speaker 20. In one embodiment of the invention, the jack hammer weighs approximately 1 gram. For a heavier jack hammer 18, a speaker 20 with a larger diameter may be required to achieve a desired level of movement or vibration.

The ornamental component 14 also includes a person 16 (also referred to herein as a “first portion”). As shown in FIG. 1, the person 16 is a model of an elf wearing a hard hat. The person 16 is coupled to the housing 13 and is movably coupled to the jack hammer 18. Although in this embodiment the first portion is modeled to represent a person, the invention covers any three-dimensional decorative object comprising a first portion which is coupled to the base and movably coupled to a second portion.

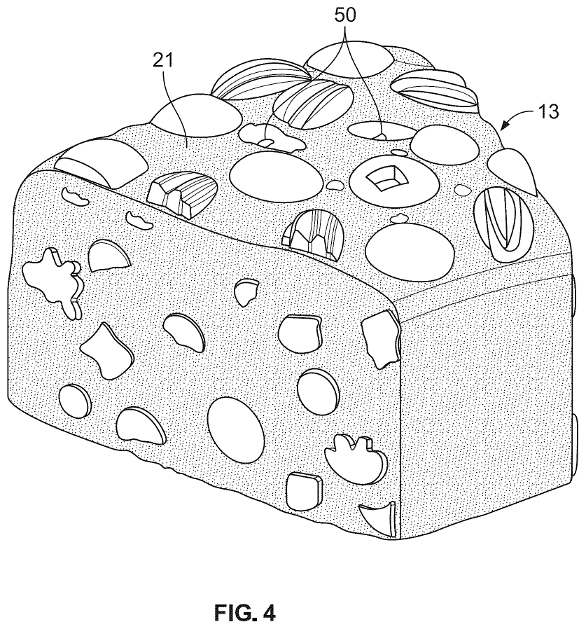

As shown in FIG. 2, the person has two appendages 49 which each extend from the bottom of a foot of the person. The appendages 49 are configured to be received by openings 50 in the outer surface of the top wall 21 of the housing 13, which are shown in FIG. 4. When the appendages 49 are inserted in the openings 50, the person 16 is coupled to the housing 13. The appendages 49 may further be adhered or welded to the top wall 21 of the housing 13. Alternatively, the person 16 may be coupled to the housing 13 in any manner that is commonly known to those with ordinary skill in the art.

The person 16 also has arms 17, as shown in FIG. 2. The person 16 is modeled to represent a person holding the handle bars 51 of the jack hammer 18. The arms 17 are configured to move when the speaker 20 vibrates, whereas the remainder of the person (i.e., the torso, head, and legs) is configured to be anchored to the housing 13 and not move when the speaker 20 vibrates. The arms 17 are coupled to a body or torso 15 of the person 16. As shown in FIG. 21, each arm 17 has an end mounted within openings or sockets in the body 15 such that the arms 17 are movable while remaining coupled to the body 15. As shown in FIG. 1, the opposite end of the arms 17 (i.e., the hands of the person) are mounted to the handle bars 51 of the jack hammer 18.

The handle bars 51 of the jack hammer 18 are securely mounted to the arms 17 and both are configured to move together relative to the body 45 of the jack hammer 18 and the person 16. Although the ornamental component 14 of this embodiment includes handle bars 51 and arms 17 (the handle bars and arms referred to herein as a “third portion”), the invention covers any three-dimensional decorative object having an ornamental component 14 comprising a third portion configured to move relative to the first and second portions.

As shown in FIG. 19, the handle bars 51 include an elongated component 53 movably coupled to the body 45 of the jack hammer 18. The elongated component 53 extends through a channel 55 defined by the body 45 of the jack hammer 18 such that ends 54 of the handle bars 51 are positioned outside the volume defined by the body 45 of the jack hammer 18.

The handle bars 51 have an appendage component 56 that is positioned generally at the center of and extends downward from the elongated component 53. The appendage component 56 is slidably coupled to the body 45 of the jack hammer 18 within the channel 55. The body 45 has a post 57 positioned within the volume defined by the body 45. A notch of the appendage component 56 slidably receives the post 57 to position the handle bars 51 within the body 45 of the jack hammer 18, while allowing the handle bars 51 to move with respect to the body 45.

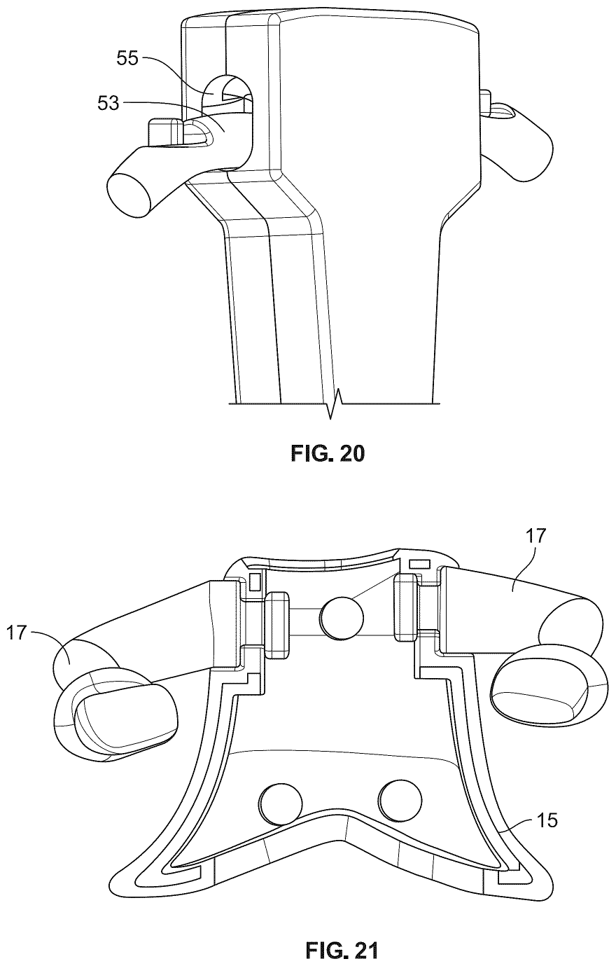

The handle bars 51 are configured to move with respect to the body 45 of the jack hammer 18 when the speaker 20 vibrates. As shown in FIG. 20, the opening of the channel 55 is oblong such that the height of the opening is greater than the width. The shape of the opening allows the elongated component 53 to move within the channel 55. The movement of the elongated component 53 is stopped by the upper and lower surfaces of the opening. In this embodiment, the handle bars 51 may move in a seesaw motion when the speaker 20 vibrates. Alternatively, the handle bars 51 may be configured to move in any way that is known to one skilled in the art.

As mentioned above, in use, the three-dimensional decorative object 10 may be configured to be displayed on a surface. The three-dimensional decorative object 10 may also be displayed by hanging from a string (e.g., the object may be hung as an ornament on a tree). Accordingly, the three-dimensional decorative object 10 may also contain a hook, loop, or any other opening such that a string or yarn may be attached to the three-dimensional decorative object 10. For example, as shown in FIG. 2, an opening 38 is on top of the person's 16 hat.

When the actuator 37 is pressed, the speaker 20 is powered and causes the shaft 47 and body 45 of the jack hammer 18 to move up and down or vibrate with respect to the base 12. Movement of the shaft 47 and body 45 also causes the handle bars 51 of the jack hammer 18 and arms 17 of the person 16 to move or vibrate with respect to the body 45 of the jack hammer 18 and the body 15 of the person 16.

While one embodiment of a three-dimensional decorative object is described above and shown in the drawings, the invention described herein covers any type of three-dimensional decorative object having an ornamental component that moves in response to vibration, including an ornamental component comprising a first portion that is coupled to a base and a second portion that is movably coupled to the first portion, wherein the second portion is positioned adjacent the speaker and configured to move relative to the first portion when the speaker vibrates. For example, the three-dimensional decorative object may be a plush toy, any type of ornament, or an object made from paper or paperboard such as a greeting card. The movable second portion may simulate the movement of construction equipment, drums, appliances, science-fiction scenes, or the moving mouth of a person. The movable second portion may also be a lever that moves a third portion through a desired range of motion as the speaker vibrates. Further, the speaker may emit sound that complements the type of decorative object as the speaker vibrates to move the second portion. The vibration of the speaker may also be used to move water or create bubbles.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. A three-dimensional decorative object comprising:
a base;
a speaker coupled to the base; and
an ornamental component comprising a first portion that is coupled to the base and a second portion that is movably coupled to the first portion,
wherein the second portion is positioned adjacent the speaker, and wherein the second portion is configured to move relative to the first portion when the speaker vibrates.

2. The three-dimensional decorative object of claim 1, wherein the base comprises a housing and a speaker mount coupled to the housing, and wherein the speaker mount mounts the speaker to the housing.

3. The three-dimensional decorative object of claim 2, further comprising a film coupled to the speaker, wherein the film is positioned between the speaker and the second portion.

4. The three-dimensional decorative object of claim 3, wherein the second portion is adhered to the film.

5. The three-dimensional decorative object of claim 1, wherein the speaker is positioned within a volume defined by the base.

6. The three-dimensional decorative object of claim 4, wherein the second portion extends through an opening in the base.

7. The three-dimensional decorative object of claim 1, wherein the base comprises a housing and a guide coupled to the housing, wherein the second portion is slidably mounted to the guide.

8. The three-dimensional decorative object of claim 1, wherein the ornamental component further comprises a third portion, wherein the third portion is configured to move relative to the first portion and the second portion.

9. The three-dimensional decorative objective of claim 8, wherein the third portion comprises:
an elongated component movably coupled to the second portion; and
at least one arm extending from the elongated component and movably coupled to the first portion.

10. The three-dimensional decorative object of claim 9, wherein the elongated component extends through a channel defined by the second portion.

11. The three-dimensional decorative object of claim 9, wherein the arm of the third portion is coupled to the first portion by a socket.

12. A three-dimensional decorative object comprising:
a base;
a speaker coupled to the base; and
an ornamental component comprising a first portion that is coupled to the base, a second portion that is movably coupled to the first portion, and a third portion that is movably coupled to the first portion and the second portion,
wherein the second portion is positioned adjacent the speaker,
wherein the base comprises a housing and a guide coupled to the housing, wherein the second portion is slidably mounted to the guide, and
wherein the second portion is configured to move relative to the first portion when the speaker vibrates.

13. The three-dimensional decorative objective of claim 12, wherein the third portion comprises:
an elongated component movably coupled to the second portion; and
at least one arm extending from the elongated component and movably coupled to the first portion.

14. The three-dimensional decorative object of claim 13, wherein the base comprises a speaker mount coupled to the housing, and wherein the speaker mount mounts the speaker to the housing.

15. The three-dimensional decorative object of claim 14, further comprising a film coupled to the speaker mount, wherein the film is positioned between the speaker and the second portion, and the second portion is adhered to the film.

16. The three-dimensional decorative object of claim 15, wherein the first portion is modeled to represent a person.

17. The three-dimensional decorative object of claim 12, wherein the first portion is modeled to represent an elf wearing a hardhat.

18. The three-dimensional decorative object of claim 17, wherein the second portion is modeled to represent a body of a jackhammer.

19. The three-dimensional decorative object of claim 18, wherein the third portion comprises
an elongated component modeled to represent a handle of the jackhammer, the elongated component movably coupled to the second portion, and
a pair of arms modeled to represent arms of the elf, the pair of arms extending from the elongated component and movably coupled to the first portion.

20. The three-dimensional decorative object of claim 19, wherein the housing of the base is modeled after a fruitcake.
